(19) United States
(12) Patent Application Publication
(10) Pub. No.: US 2016/0099608 A1
(43) Pub. Date: Apr. 7, 2016

(54) POWER ADAPTER WITH BUILT-IN BATTERY AND POWER STORAGE AND SUPPLY METHOD THEREOF

(71) Applicant: JATBOK TECHNOLOGY CO., LTD., Miaoli County (TW)

(72) Inventors: Jui Pin Jao, Miaoli County (TW); Wen Fu Ho, Miaoli County (TW); Huang Pin Hsu, Miaoli County (TW)

(73) Assignee: JATBOK TECHNOLOGY CO., LTD., Miaoli County (TW)

(21) Appl. No.: 14/504,025

(22) Filed: Oct. 1, 2014

(51) Int. Cl. H02J 9/06; H02J 7/00

(52) U.S. Cl. CPC H02J 9/06; H02J 7/007; H02J 7/0021

(57) ABSTRACT

A power storage and supply method for a power adapter includes determining whether the power adapter is connected to an external power source; if yes, further determining whether the power adapter is connected to an electronic device; if yes, selecting to charge the electronic device or a battery module built in the power adapter; determining whether a physical quantity of the power adapter reaches a first reference value; and, if yes, selecting to charge the electronic device and/or the battery module. The power adapter includes a microcontroller that uses the physical quantity of the power adapter to determine charging sequence, so that the power adapter is not interfered and limited by incompatible device signal control and can be directly used to charge any electronic device while automatically switching among different charging operation states to complete charging of the electronic device and the built-in battery module in increased charging efficiency.

### FIELD OF THE INVENTION

The present invention relates to an AC to DC or a DC to DC power adapter, and more particularly, to a power adapter that has a rechargeable battery built therein and uses a physical quantity, such as any one of current, voltage, temperature and magnetic field, of the power adapter as a basis to determine charging operation, so that the charging of an electronic device via the power adapter is not interfered and limited by incompatible signal control between the electronic device and the power adapter.

### BACKGROUND OF THE INVENTION

A rechargeable battery is mainly used on various types of portable electronic devices 10, such as a laptop computer, a personal digital assistant (PDA), a cell phone, a camera and the like. Please refer to FIG. 1. The rechargeable battery for the electronic device 10 is usually charged via a power adapter 11 that is connected to a power connector 12 on an external power source 13.

The currently available power adapter 11 has only one function of converting the external power source to a current type needed by the rechargeable battery in the electronic device 10, and can not serve as a power storage device. When a user wants to charge the electronic device, he or she has to purchase a power bank and connects the power adapter 11 to the power bank for charging the electronic device 10.

To improve the conventional power adapter and avoid the inconvenience of purchasing an additional power bank, there has been developed a power adapter 11 with a battery module 14 built therein for storing electric power for use later, as shown in FIG. 2. However, this type of power adapter 11 includes complicated circuit control and has a relatively large volume, and is usually connected to an external power source 13 for charging an electronic device 10 connected to the power adapter 11. The battery module 14 in the power adapter 11 will not be charged until the electronic device 10 is fully charged. Therefore, a quite long time is needed to fully charge the electronic device 10 and the battery module 14 to result in low charging efficiency.

U.S. Pat. No. 8,487,476 discloses a power adapter having a charging determination mechanism. According to the charging/discharging determination mechanism of this type of power adapter, it is necessary to check whether the battery capacity of an electronic device being charged reaches a first threshold and then check whether the capacity of the battery module of the power adapter reaches a second threshold. Only when the above two sequence conditions are met, can the battery module be used to charge the electronic device. Therefore, one condition for this charging determination mechanism to work is the electronic device must provide a signal. In the case the electronic device does not respond to or is incompatible with the signal transmitted from the power adapter, or even interferes with or limits the power adapter, it would result in an interrupted charging procedure.

### SUMMARY OF THE INVENTION

A primary object of the present invention is to provide a power storage and supply method for a power adapter with built-in battery, so that the power adapter can be directly used to charge any existing electronic device, such as a smartphone, a tablet computer or a power bank, without being interfered and limited by the signal control of the electronic device being charged.

Another object of the present invention is to provide a power adapter that includes a microcontroller, which uses a physical quantity, such as the current, temperature, voltage or magnetic field, of the power adapter, as a basis for controlling different charging operation states, such as charging control, charging sequence and whether to keep charging, among an external power source, a battery module built in the power adapter and an electronic device connected to the power adapter for charging, so that the electronic device and the battery module can be fully charged in increased efficiency.

To achieve the above and other objects, a first preferred embodiment of the power storage and supply method for a power adapter with built-in battery according to the present invention includes the following steps: (A) determining whether or not the power adapter is connected to an external power source; wherein the power adapter includes at least one microcontroller, a power system, and at least one battery module built in the power adapter; (B) if yes, further determining whether or not the power adapter is connected to at least one electronic device; (C) if yes, selecting to charge either the electronic device or the battery module as a first charging mode; (D) determining whether or not a physical quantity of the power adapter reaches a first reference value; (E) if yes, selecting to charge the electronic device and/or the battery module as a second charging mode; (F) charging the battery module of the power adapter via the external power source when the power adapter is not connected to the electronic device; and (G) charging the electronic device via the battery module of the power adapter when the power adapter is not connected to the external power source.

According to the first preferred embodiment of the method of the present invention, the step (E) further includes the steps of determining whether or not the physical quantity of the power adapter reaches a second reference value, and, if yes, stopping charging the battery module or stopping charging the battery module and the electronic device.

The step (F) further includes the steps of determining whether or not the physical quantity of the power adapter reaches a third reference value, and, if yes, stopping charging the battery module via the external power source.

And, the step (G) further includes the steps of determining whether or not the physical quantity of the power adapter reaches a fourth reference value, and, if yes, stopping charging the electronic device via the battery module.

According to a first operable embodiment, in the first charging mode, the electronic device is charged at a first priority, and in the second charging mode, the electronic device and the battery module are charged at the same time. Alternatively, according to another operable embodiment, in the first charging mode, the electronic device is charged at a first priority, and in the second charging mode, the battery module is charged.

According to a second operable embodiment of the present invention, in the first charging mode, the battery module is charged at a first priority, and in the second charging mode, the electronic device and the battery module are charged at the same time. Alternatively, according to another operable embodiment, in the first charging mode, the battery module is charged at a first priority, and in the second charging mode, the electronic device is charged.

Wherein, in the second charging mode, either the external power source or the battery module can be used to supply the current for charging. Further, the physical quantity can be current, temperature, voltage or magnetic field for using as a charging determination mechanism in the present invention.

To achieve the above and other objects, a second preferred embodiment of the power storage and supply method for a power adapter with built-in battery according to the present invention includes the following steps: (A) determining whether or not the power adapter is connected to an external power source; wherein the power adapter includes at least one microcontroller, a power system and at least one battery module built in the power adapter; (B) if yes, further determining whether or not the power adapter is connected to at least one electronic device; (C) if yes, charging the electronic device and the battery module at the same time as a first charging mode; (D) determining whether or not a first physical quantity of the power adapter reaches a first reference value; (E) if yes, stopping the charging to the electronic device as a second charging mode; (F) charging the battery module of the power adapter via the external power source when the power adapter is not connected to the electronic device; and (G) charging the electronic device via the battery module of the power adapter when the power adapter is not connected to the external power source.

In the second preferred embodiment of the method of the present invention, the step (E) further includes the following steps: determining whether or not the first physical quantity of the power adapter reaches a second reference value; and if yes, stopping charging the battery module. On the other hand, if the first physical quantity of the power adapter does not reach the second reference value, the following steps are included: further determining whether or not a second physical quantity of the power adapter reaches a fifth reference value; if yes, temporarily stopping charging the battery module; determining whether or not the second physical quantity of the power adapter reaches a sixth reference value; and if yes, resuming charging the battery module.

In the second preferred embodiment of the method of the present invention, the step (F) further includes the following steps: determining whether or not the first physical quantity of the power adapter reaches a third reference value; and if yes, stopping charging the battery module via the external power source.

In the second preferred embodiment of the method of the present invention, the step (G) further includes the following steps: determining whether or not the first physical quantity of the power adapter reaches a fourth reference value; and if yes, stopping charging the electronic device via the battery module.

In the second preferred embodiment of the power storage and supply method for a power adapter with built-in battery according to the present invention, the first physical quantity is electric current and the second physical quantity is temperature.

To achieve the above and other objects, the power adapter with built-in battery according to the present invention can be selectively connected to an external power source and/or at least one electronic device, and includes an input connector for electrically connecting to the external power source; at least one output connector for electrically connecting to the at least one electronic device; a power system being electrically connected to between the input connector and the output connector for converting current and voltage received from the external power source; a built-in battery module being electrically connected to the power system and the output connector for storing power supplied by the power system; and a microcontroller being electrically connected to the input connector, the output connector, the power system and the battery module for determining states of connection of the input connector and the output connector to the external power source and the electronic device, respectively, and, based on the determined connection states, selectively instructing the power system to supply power to the battery module and/or the output connector or instructing the battery module to supply power to the output connector.

When the input connector and the output connector are simultaneously connected to the external power source and the electronic device, respectively, the power system charges the electronic device or the battery module as a first charging mode; and when the microcontroller detects a physical quantity of the power adapter reaches a first reference value, the power system charges the battery module and/or the electronic device as a second charging mode.

In summary, when the power adapter of the present invention is connected to an electronic device and an external power source, the microcontroller of the power adapter uses a physical quantity, such as current, voltage, temperature or magnetic field, as a charging determination basis. The microcontroller also uses the occurrence of a first, a second, a third and a fourth reference value to perform different charging operation states, such as charging control, charging sequence and whether to keep charging, among the external power source, the battery module and the connected electronic device, so that the electronic device and the battery module can be fully charged in increased efficiency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing the application of a conventional power adapter;

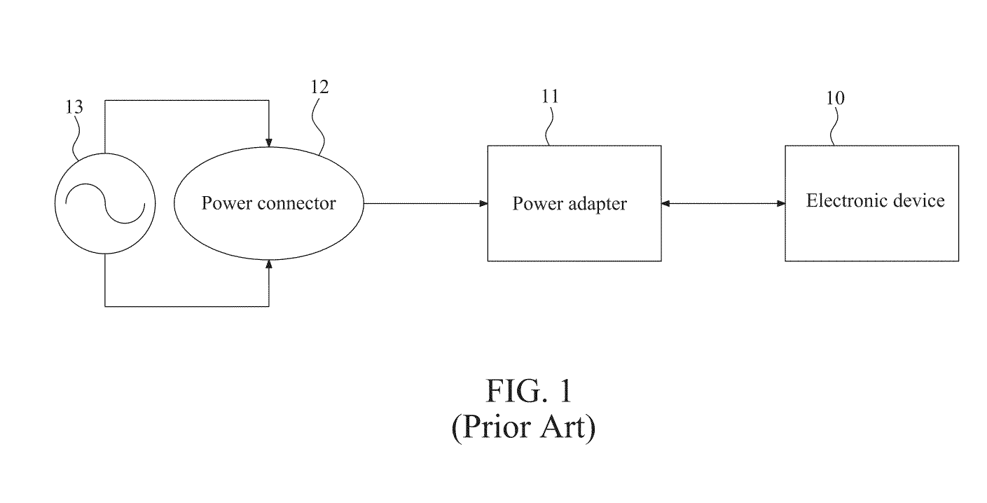

FIG. 2 is a block diagram showing the structure of another conventional power adapter with built-in battery;

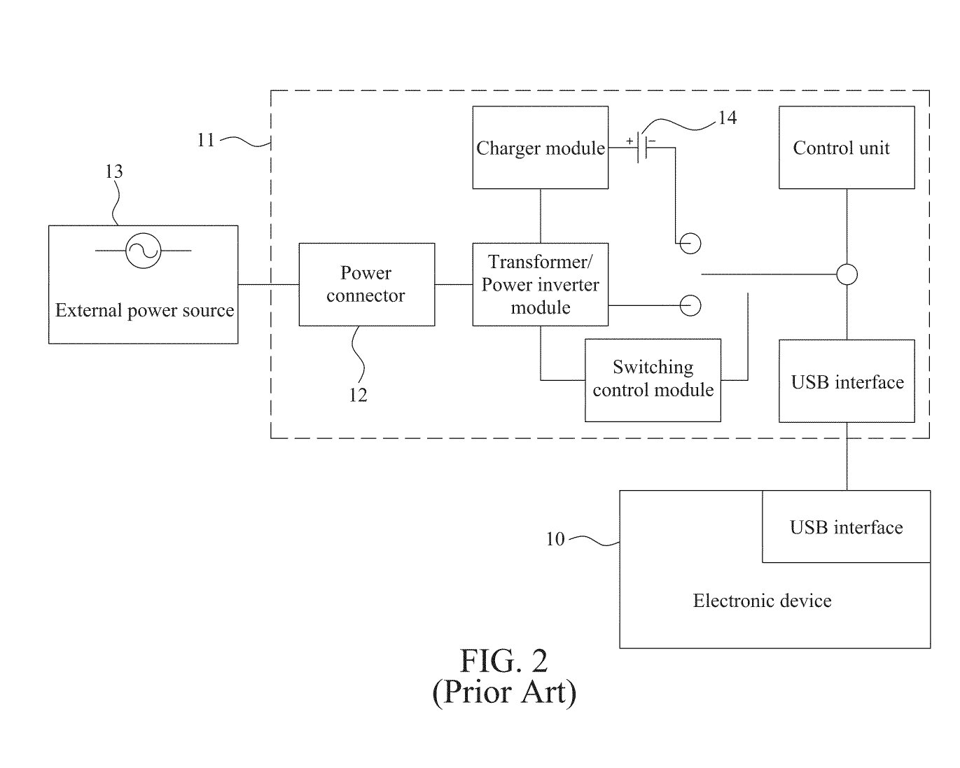

FIG. 3 is a block diagram showing the structure of a power adapter according to the present invention;

FIG. 4 is a current-based test diagram showing the use of a power adapter of 5V/1 A according to the present invention to charge an electronic device;

FIG. 5 is a block diagram showing a first operation manner of the power adapter of the present invention, in which the current output of the power adapter is used as a charging determination mechanism;

FIG. 6 is a block diagram showing a second operation manner of the power adapter of the present invention, in which the current output of the power adapter is used as a charging determination mechanism;

FIG. 7 is a temperature-based test diagram showing the use of a power adapter of 5V/1 A according to the present invention to charge an electronic device;

FIG. 8 is a block diagram showing a third operation manner of the power adapter of the present invention, in which the temperature of the power adapter is used as a charging determination mechanism;

FIG. 9 is a block diagram showing a fourth operation manner of the power adapter of the present invention, in which the temperature of the power adapter is used as a charging determination mechanism;

FIG. 10 is a flowchart showing the steps included in a first preferred embodiment of a power storage and supply method according to the present invention for a power adapter with built-in battery that operates in the manner shown in FIG. 9;

FIG. 11 is a block diagram showing a fifth operation manner of the power adapter of the present invention, in which the current output and the temperature of the power adapter are used at the same time as a charging determination mechanism;

FIG. 12 is a flowchart showing the steps included in a second preferred embodiment of a power storage and supply method according to the present invention for a power adapter with built-in battery that operates in the manner shown in FIG. 11;

FIG. 13 is a block diagram showing the charging sequence according to the conventional power adapter with built-in battery;

FIG. 14 is a block diagram showing a first charging sequence according to the power adapter of the present invention;

FIG. 15 is a block diagram showing a second charging sequence according to the power adapter of the present invention; and

FIG. 16 is a block diagram showing a third charging sequence according to the power adapter of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

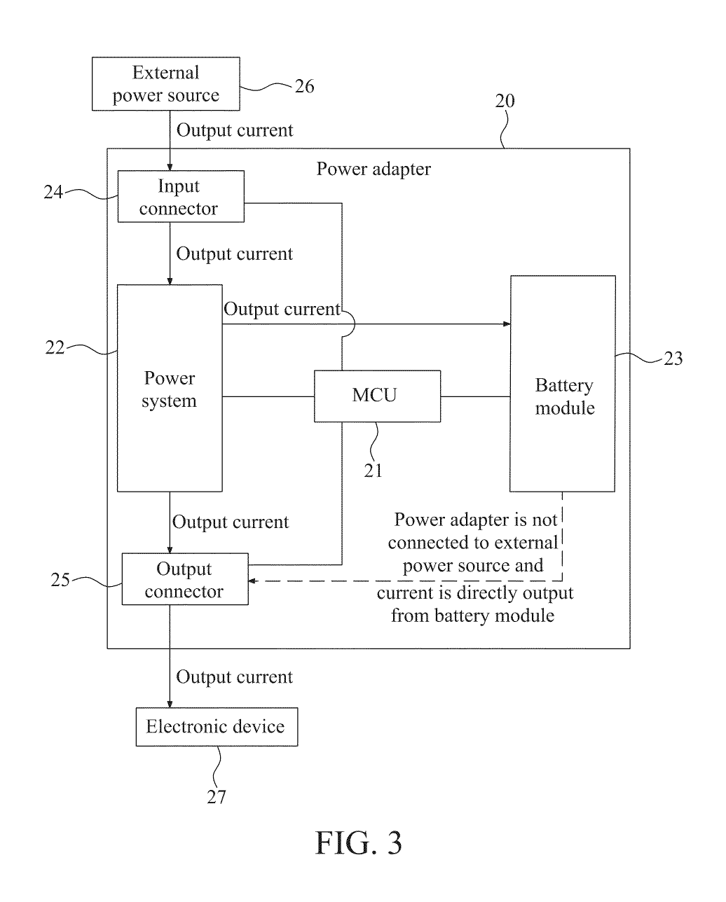

Please refer to FIG. 3 that is a block diagram showing the structure of a power adapter with built-in battery according to a preferred embodiment of the present invention. For the purpose of conciseness and clarity, the present invention is also briefly referred to as the power adapter and generally denoted by reference numeral 20 herein. As shown, the power adapter 20 includes a microcontroller (MCU) 21, a power system 22, a battery module 23 built in the power adapter 20, an input connector 24 and an output connector 25. The power adapter 20 can be selectively connected to an external power source 26 and/or at least one electronic device 27.

The external power source 26 can be electrically connected to the input connector 24 to supply electric power to the power system 22, which converts the current and voltage received from the external power source 26 from alternating current to direct current (AC to DC) or from direct current to direct current (DC to DC). The battery module 23 is electrically connected to the power system 22 and the output connector 25 for storing the current supplied thereto from the power system 22. The microcontroller 21 detects and determines the present connection state of the power adapter 20 and selectively causes the power system 22 to supply power to the battery module 23 for storage or supply power to the electronic device 27 and charge the same via the output connector 25, which is electrically connected to between the power system 22 and the electronic device 27.

It is understood the above described embodiment is only illustrative and not intended to limit the present invention in any way. That is, while not shown, the numbers of the microcontroller 21, the battery module 23 and the output connector 25 can be more than one according to actual need in use.

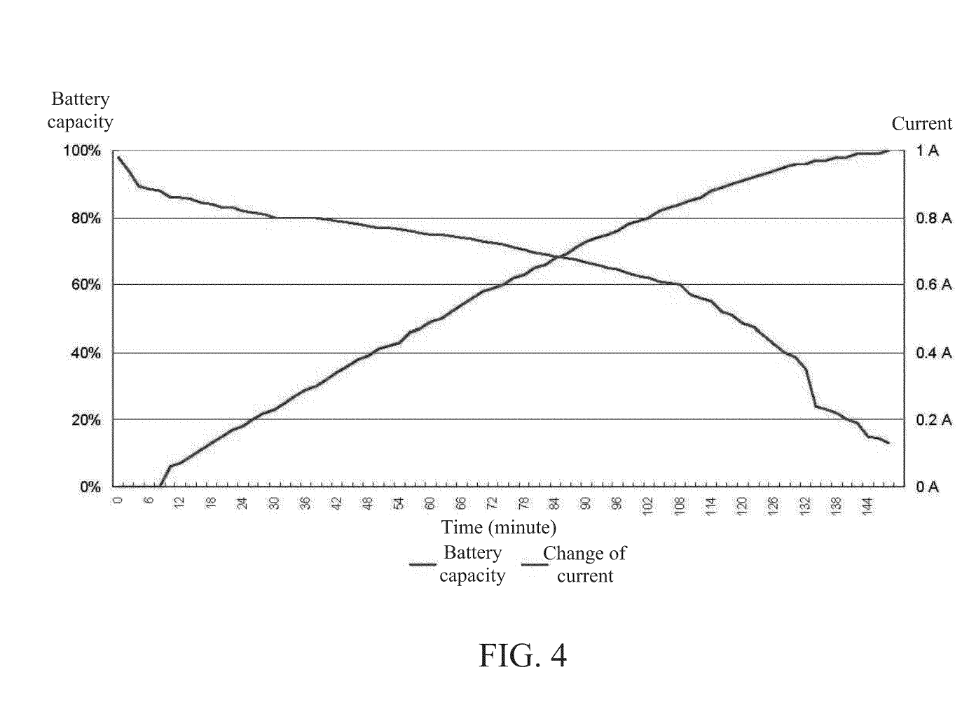

Please refer to FIG. 4, which is a current-based test diagram showing the use of a power adapter 20 of 5V/1 A of the present invention to charge a smartphone. The current-based test diagram records change of the current being charged to the smartphone and change of the battery capacity of the smartphone over different charging time. In FIG. 4, the x-axis indicates the charging time in minute, the left y-axis indicates the battery capacity of the smartphone, and the right y-axis indicates the charging current to the smartphone.

As shown in FIG. 4, when the battery capacity of the smartphone is 0%, the charging current is 1 A; when the battery capacity of the smartphone is 80%, the charging current is about 0.6 A; and when the battery capacity of the smartphone is 95%, the charging current is about 0.4 A. From the current-based test diagram of FIG. 4, it can be seen that the charging current decreases quickly when the battery capacity of the smartphone is higher than 80%, and this is a characteristic generally observed in charging an electronic device with a power adapter.

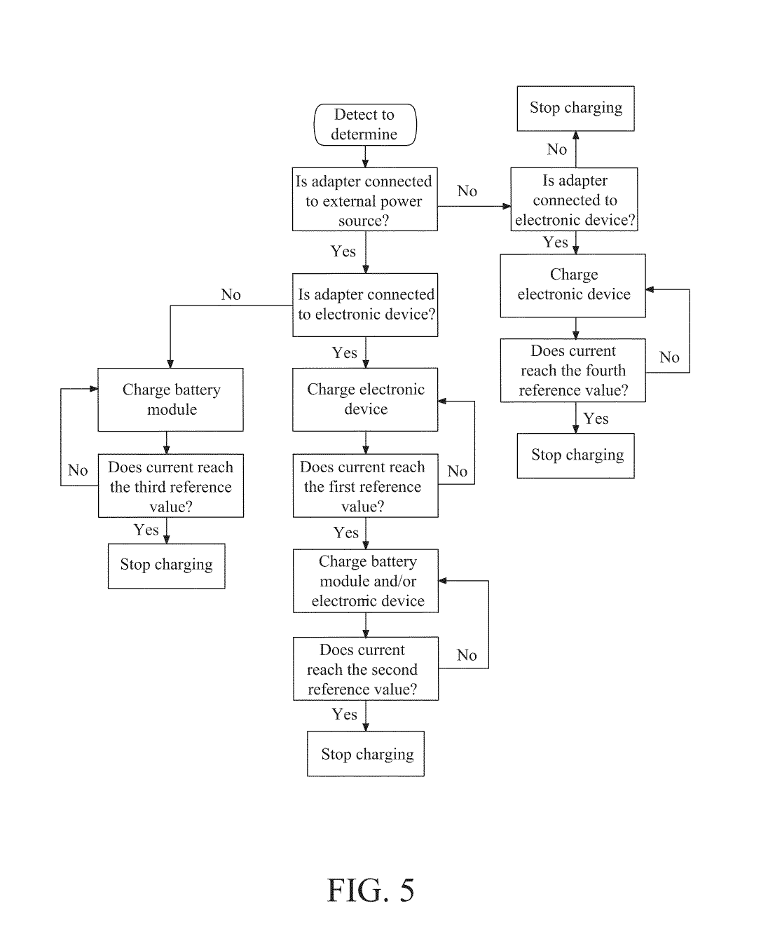

FIG. 5 is a block diagram showing a first operation manner of the power adapter 20 of the present invention, in which the current output of the power adapter 20 is used as a charging determination mechanism. First, the microcontroller 21 detects and determines whether the power adapter 20 is connected to an external power source 26. No matter the power adapter 20 is or is not connected to an external power source 26, the microcontroller 21 further determines whether the power adapter 20 is connected to an electronic device 27.

In the case the microcontroller 21 detects that the power adapter 20 has been connected to both of an external power source 26 and an electronic device 27, the electronic device 27 is charged via the external power source 26. When the output current of the power system 22 reaches a first reference value, the microcontroller 21 can select to charge only the battery module 23 in the power adapter 20 or to charge the electronic device 27 and the battery module 23 at the same time. When the output current of the battery module 23 reaches a second reference value, the microcontroller 21 can stop charging the battery module 23 or stop charging the battery module 23 and the electronic device 27 at the same time.

On the other hand, in the case the microcontroller 21 detects that the power adapter 20 has been connected to an external power source 26 but not to an electronic device 27, the battery module 23 in the power adapter 20 is charged via the external power source 26. When the output current of the battery module 23 reaches a third reference value, the microcontroller 21 stops charging the battery module 23 via the external power source 26.

Or, in the case the microcontroller 21 detects that the power adapter 20 is not connected to any of the external power source 26 and the electronic device 27, the microcontroller 21 does not make any movement so as to reserve the power of the battery module 23.

Or, in the case the microcontroller 21 detects that the power adapter 20 is not connected to an external power source 26 but to an electronic device 27, the electronic device 27 is charged via the battery module 23 of the power adapter 20. When the output current of the battery module 23 reaches a fourth reference value, the microcontroller 21 stops charging the electronic device 27 via the battery module 23.

According to an operable embodiment of the present invention, as can be seen in FIG. 4, all the reference values are indicated as a percentage of the maximum current output, i.e. 1 A. For instance, the first reference value can be set to be 20%. That is, when the output current of the power system 22 to the electronic device 27 is smaller than 0.2 A, the current is divided to charge the battery module 23 and the electronic device 27 at the same time. Or, the first reference value can be set to be 10%. That is, when the output current of the power system 22 to the electronic device 27 is smaller than 0.1 A, the current is supplied only to charge the battery module 23. And, the second reference value can be set to be 10%. That is, when the current output of the battery module 23 is smaller than 0.1 A, the charging current to the battery module 23 is stopped. The third reference value can be set to 10%. That is, when the current output of the power system 22 to the battery module 23 is smaller than 0.1 A, the charging current to the battery module 23 is stopped. And, the fourth reference value can be set to be 5%. That is, when the current output of the battery module 23 to the electronic device 27 is smaller than 0.05 A, the charging current to the electronic device 27 is stopped.

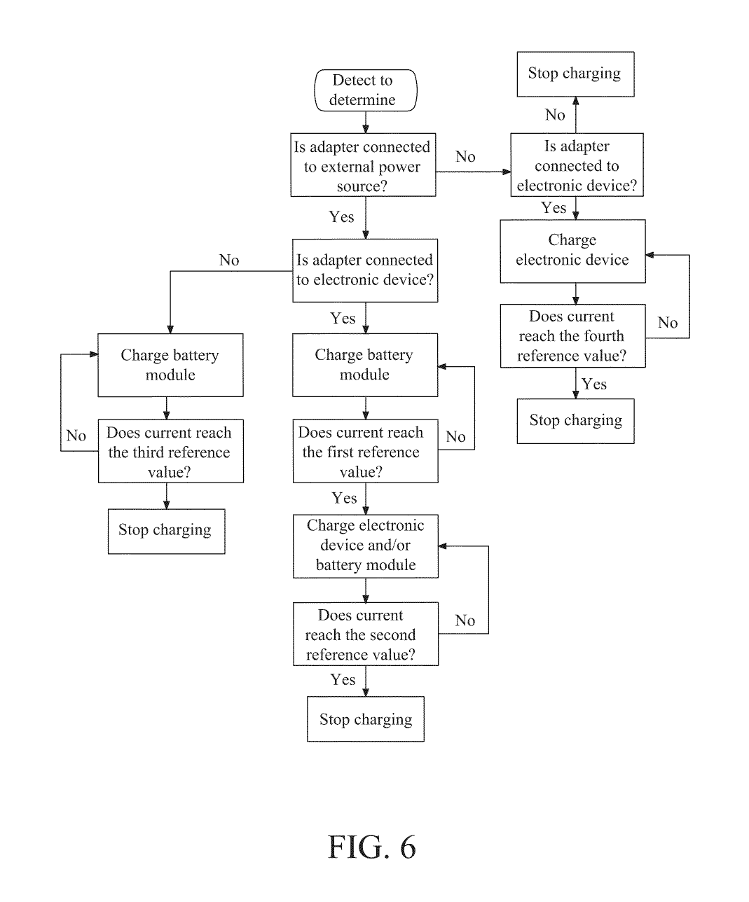

Alternatively, according to a second operation manner of the power adapter 20 as shown in FIG. 6, in the case the microcontroller 21 detects that the power adapter 20 has been connected to both of an external power source 26 and an electronic device 27, the battery module 23 can be charged via the external power source 26 at a first priority. When the output current of the power system 22 to the battery module 23 reaches a first reference value, the microcontroller 21 can select to charge only the electronic device 27 or to charge the battery module 23 and the electronic device 27 at the same time. When the output current of the power system 22 reaches a second reference value, the microcontroller 21 can stop charging the electronic device 27 or stop charging the battery module 23 and the electronic device 27 at the same time.

That is, in the illustrated first and second operation manners of the power adapter 20 according to the present invention, the natural phenomenon that the charging current to the electronic device 27 decreases with the increase of the battery capacity of the electronic device 27 is used to determine that the power adapter 20 still has extra current for use and accordingly, the extra charging current is used to charge the battery module 23 of the power adapter 20. In this way, the power adapter 20 can have upgraded charging efficiency.

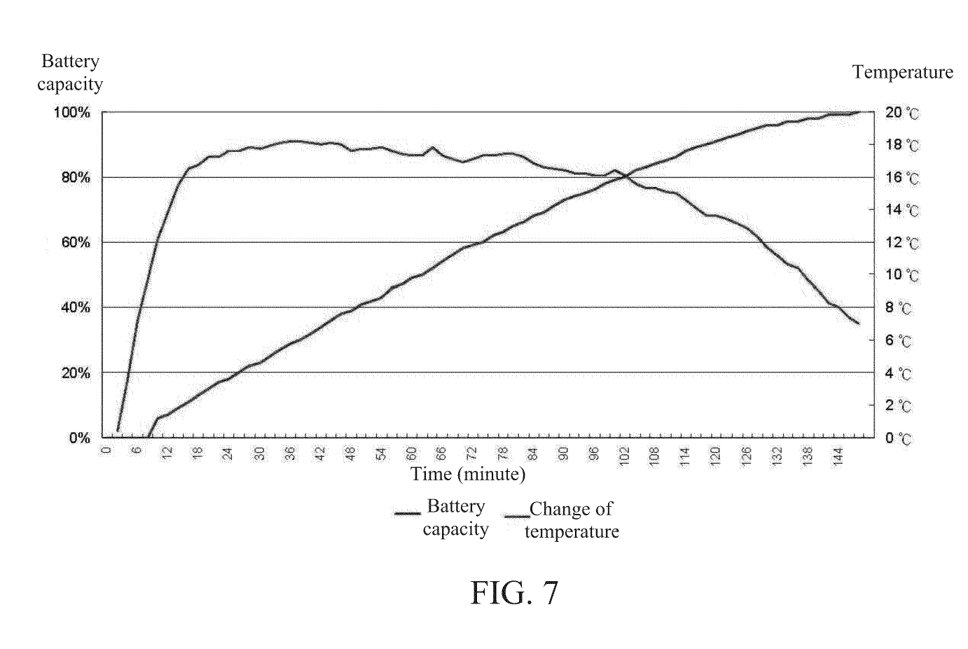

Please refer to FIG. 7, which is a temperature-based test diagram showing the use of a power adapter 20 of 5V/1 A according to the present invention to charge a smartphone. The temperature-based test diagram records change of the temperature of the power adapter 20 when charging current to the smartphone and change of the battery capacity of the smartphone over different charging time. In FIG. 7, the x-axis indicates the charging time in minute, the left y-axis indicates the battery capacity of the smartphone in percentage, and the right y-axis indicates the corresponding temperature rising of the power adapter 20 in ° C.

As shown in FIG. 7, when the battery capacity of the smartphone is about 32%, the power adapter 20 has a temperature about 18° C.; when the battery capacity of the smartphone is about 80%, the power adapter 20 has a temperature about 16° C.;

and when the battery capacity of the smartphone is about 95%, the power adapter 20 has a temperature about 12° C. As can be seen from the temperature-based test diagram of FIG. 7, the temperature of the power adapter 20 drops quickly when the battery capacity of the smartphone is higher than 80%, and this is a characteristic generally observed in charging an electronic device with a power adapter.

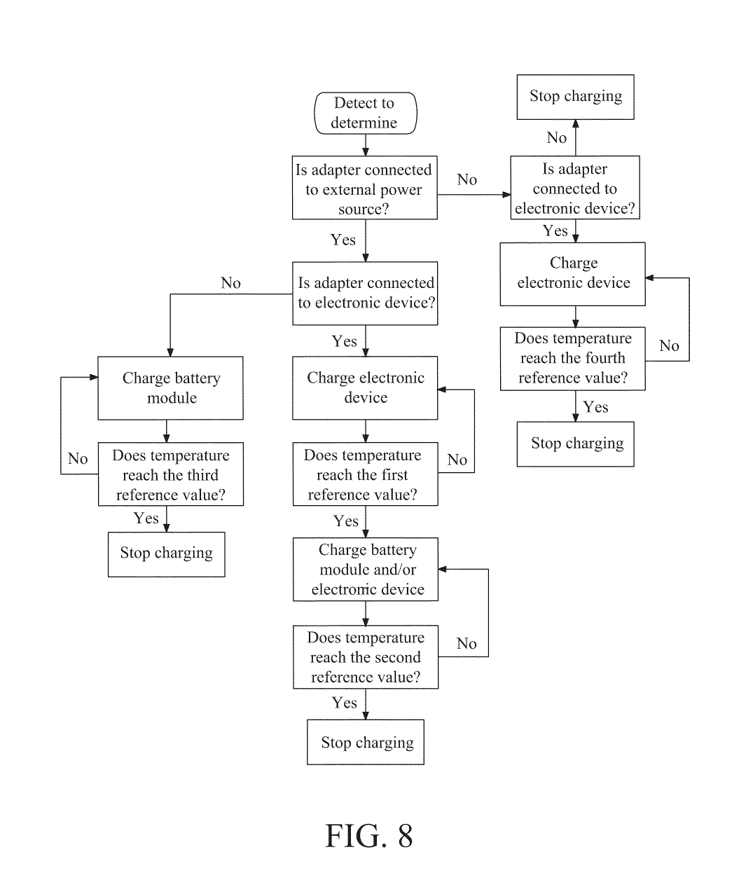

FIG. 8 is a block diagram showing a third operation manner of the power adapter 20 of the present invention, in which the temperature of the power adapter 20 is used as a charging determination mechanism. First, the microcontroller 21 determines whether the power adapter 20 is connected to an external power source 26. No matter the power adapter 20 is or is not connected to an external power source 26, the microcontroller 21 further determines whether the power adapter 20 is connected to an electronic device 27.

In the case the microcontroller 21 detects that the power adapter 20 has been connected to both of an external power source 26 and an electronic device 27, the electronic device 27 is charged via the external power source 26. When an internal temperature of the power adapter 20 reaches a first reference value, the microcontroller 21 can select to charge only the battery module 23 of the power adapter 20 or to charge the electronic device 27 and the battery module 23 at the same time. When the internal temperature of the power adapter 20 reaches a second reference value, the microcontroller 21 can stop charging the battery module 23 or stop charging the battery module 23 and the electronic device 27 at the same time.

On the other hand, in the case the microcontroller 21 detects that the power adapter 20 has been connected to an external power source 26 but not to an electronic device 27, the battery module 23 of the power adapter 20 is charged via the external power source 26. When the internal temperature of the power adapter 20 reaches a third reference value, the microcontroller 21 stops charging of the battery module 23 via the external power source 26.

Or, in the case the microcontroller 21 detects that the power adapter 20 is not connected to any of the external power source 26 and the electronic device 27, the microcontroller 21 does not make any movement so as to reserve the power of the battery module 23.

Or, in the case the microcontroller 21 detects that the power adapter 20 is not connected to an external power source 26 but to an electronic device 27, the electronic device 27 is charged via the battery module 23 of the power adapter 20. When the internal temperature of the battery module 23 reaches a fourth reference value, the microcontroller 21 stops charging of the electronic device 27 via the battery module 23.

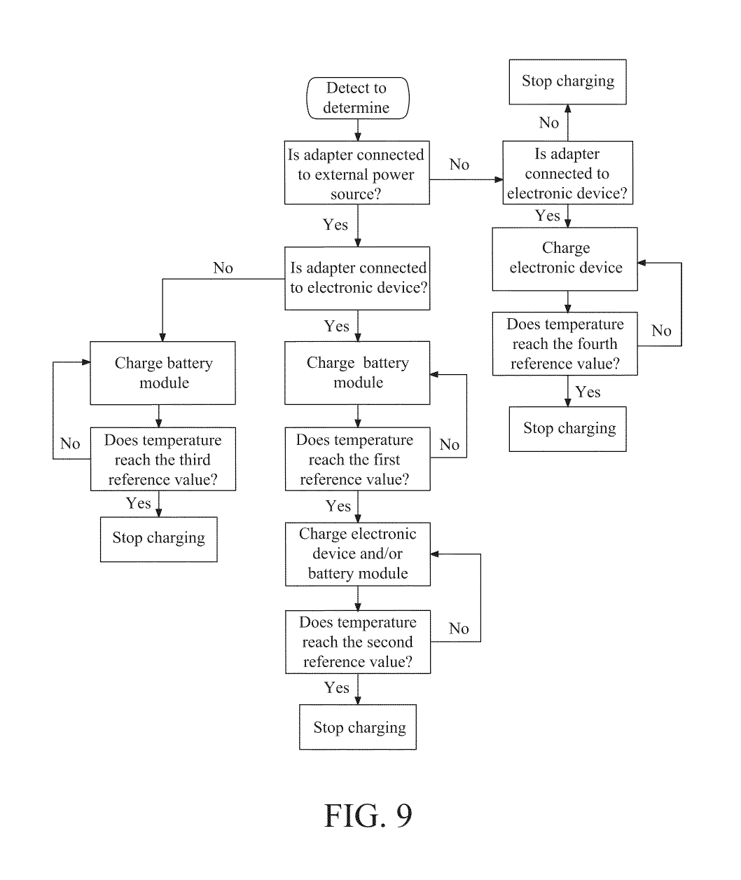

Alternatively, according to a fourth operation manner of the power adapter 20 as can be seen from FIG. 9, in the case the microcontroller 21 detects that the power adapter 20 has been connected to both of an external power source 26 and an electronic device 27, the battery module 23 of the power adapter 20 can be charged via the external power source 26 at a first priority. When the internal temperature of the power adapter 20 reaches a first reference value, the microcontroller 21 can select to charge only the electronic device 27 or to charge the battery module 23 and the electronic device 27 at the same time. When the internal temperature of the power adapter 20 reaches a second reference value, the microcontroller 21 can stop charging the electronic device 27 or stop charging the battery module 23 and the electronic device 27 at the same time.

That is, in the third and fourth operation manners of the power adapter 20 according to the present invention, the natural phenomenon that the temperature of the power adapter 20 decreases with the increase of the battery capacity of the electronic device 27 is used to determine that the power adapter 20 still has extra current for use and accordingly, the extra charging current is used to charge the battery module 23 of the power adapter 20. In this way, the power adapter 20 can have upgraded charging efficiency.

From the above two preferred embodiments of the present invention, it can be found the microcontroller 21 of the power adapter 20 can use the change of the power adapter's current output or the change of the power adapter's temperature as a determining basis to change the charging operation states, such as charging control, charging sequence and whether to keep charging, among the external power source 26, the internal battery module 23 and the electronic device 27. However, it is understood the above two preferred embodiments are only illustrative and not intended to limit the present invention in any way. For example, in the present invention, other different physical quantities, such as voltage and magnetic field, can also be adopted by the microcontroller 21 of the power adapter 20 as a basis to make detection and determination in controlling the charging of the battery module 23 and the electronic device 27.

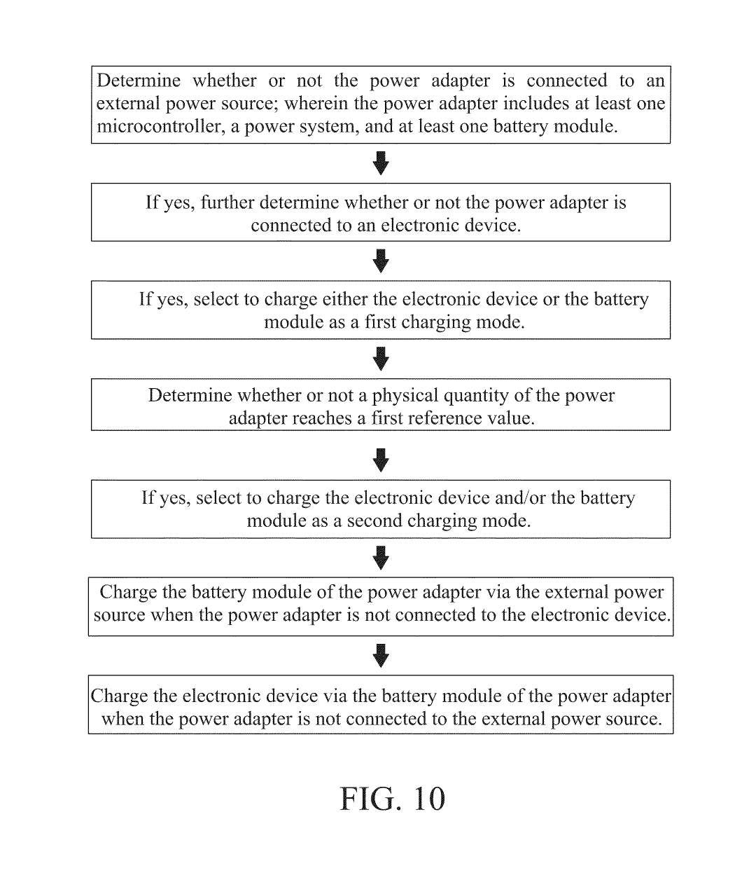

The present invention also provides a power storage and supply method for the above-described power adapter 20. Please refer to FIG. 10, which is a flowchart showing the steps included in a first preferred embodiment of the power adapter's power storage and supply method according to the present invention. The following is a detailed description of these steps, which are numbered from (A) to (G) herein for ease of reference. Step (A): Determine whether or not the power adapter 20 is connected to an external power source 26; wherein the power adapter 20 includes a microcontroller 21, a power system 22 and a battery module 23 built in the power adapter 20. Step (B): If yes, further determine whether or not the power adapter 20 is connected to an electronic device 27. Step (C): If yes, select to charge the electronic device 27 or the battery module 23 as a first charging mode. Step (D): Determine whether or not a physical quantity of the power adapter 20 reaches a first reference value. Step (E): If yes, select to charge the electronic device 27 and/or the battery module 23 as a second charging mode. Step (F): Charge the battery module 23 of the power adapter 20 via the external power source 26 when the power adapter 20 is not connected to the electronic device 27. Step (G): Charge the electronic device 27 via the battery module 23 of the power adapter 20 when the power adapter 20 is not connected to the external power source 26.

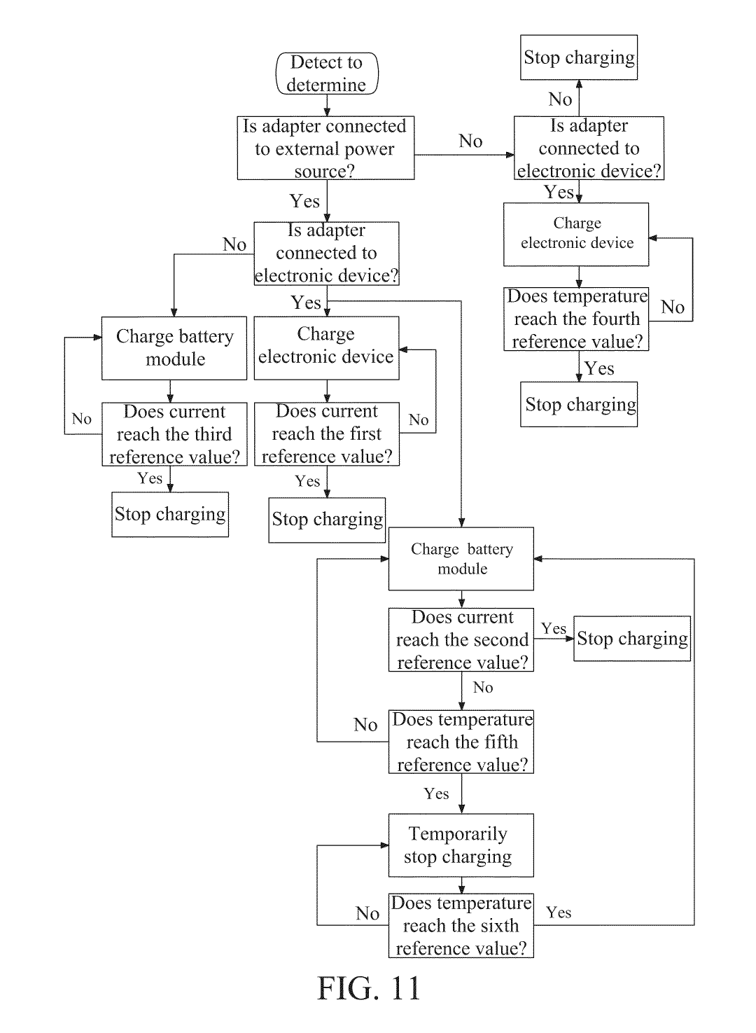

Please refer to FIG. 11. In addition to the first, the second, the third and the fourth operation manner shown in FIGS. 5, 6, 8 and 9, respectively, there is still a fifth operation manner for the power adapter 20 of the present invention. As shown in FIG. 11, when the power adapter 20 is connected to both of the external power source 26 and the electronic device 27, the electronic device 27 and the battery module 23 of the power adapter 20 are simultaneously charged via the external power source 26. When the output current of the power system 22 reaches a first reference value and this condition is detected by the microcontroller 21, the charging to the electronic device 27 via the external power source 26 is stopped. And, when the output current of the power system 22 reaches a second reference value, the charging to the battery module 23 is stopped.

On the other hand, in the case the output current of the power system 22 does not reach the second reference value, the microcontroller 21 further detects the temperature of the battery module 23 and determines whether the temperature of the battery module 23 reaches a fifth reference value.

When the temperature of the battery module 23 exceeds the fifth reference value, the microcontroller 21 will temporarily stop the charging to the battery module 23 and keeps monitoring and determines whether the temperature of the battery module 23 drops to a preset sixth reference value. When the microcontroller 21 detects that the battery module 23 has a temperature lower than the sixth reference value, the microcontroller 21 will resume the charging to the battery module 23 until the output current of the power system 22 exceeds the second reference value.

In the fifth power adapter operation manner illustrated in FIG. 11, the natural phenomena that the charging current to the power adapter 20 decreases with the increase of the battery capacity and that the temperature of the power adapter 20 decreases with the increase of the battery capacity are used to determine the charge state of the electronic device 27 and the battery module 23 of the power adapter 20. For this purpose, the battery module 23 is further provided with a relative temperature detection mechanism to ensure the temperature of the battery module 23 being charged is always maintained within a preset range. In this manner, the power adapter 20 can have upgraded charging efficiency and is safer for use.

As to some subsequent conditions, such as when the microcontroller 21 detects that the power adapter 20 is connected to the external power source 26 but not the electronic device 27, or that the power adapter 20 is not connected to either of the external power source 26 and the electronic device 27, or that the power adapter 20 is connected to the electronic device 27 but not the external power source 26, they are handled with the same operation procedures as those in the previous operation manners of the power adapter 20 and are therefore not repeatedly described herein.

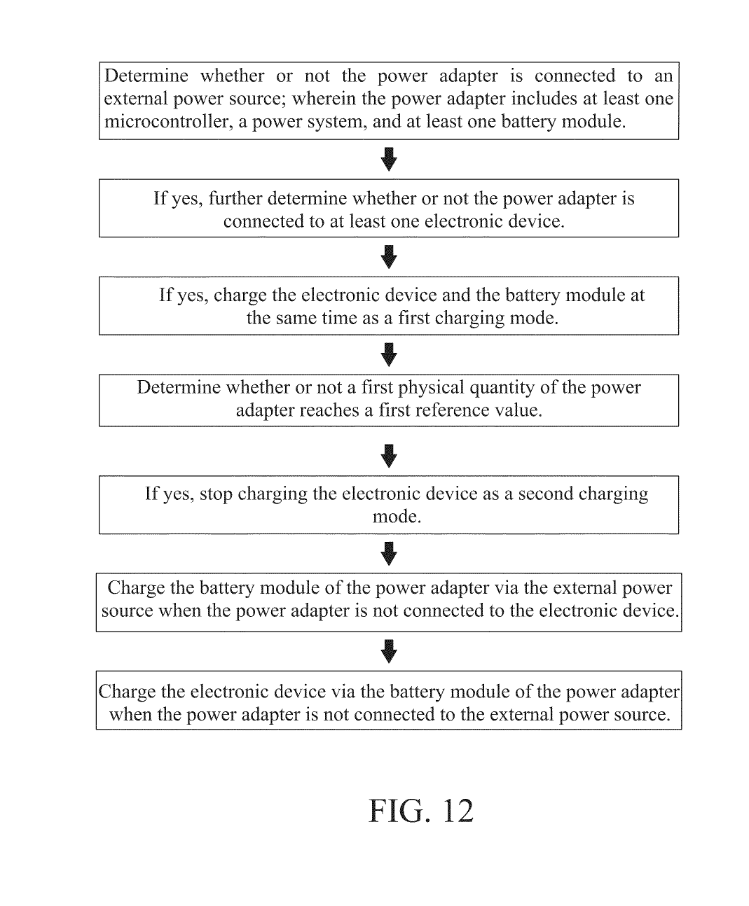

Please refer to FIG. 12. According to the fifth operation manner of the power adapter 20 shown in FIG. 11, two different physical quantities are used in combination as a charging determination mechanism. Based on the above technical feature, a second preferred embodiment of the power storage and supply method for the power adapter 20 with built-in battery according to the present invention is provided, which includes the following steps: (A) determining whether or not the power adapter 20 is connected to an external power source 26; wherein the power adapter 20 includes at least one microcontroller 21, a power system 22 and at least one battery module 23 built in the power adapter 20; (B) if yes, further determining whether or not the power adapter 20 is connected to at least one electronic device 27; (C): if yes, charging the electronic device 27 and the battery module 23 at the same time as a first charging mode; (D) determining whether or not a first physical quantity of the power adapter 20 reaches a first reference value; (E) if yes, stopping the charging to the electronic device 27 as a second charging mode; (F) charging the battery module 23 of the power adapter 20 via the external power source 26 when the power adapter 20 is not connected to the electronic device 27; and (G) charging the electronic device 27 via the battery module 23 of the power adapter 20 when the power adapter 20 is not connected to the external power source 26.

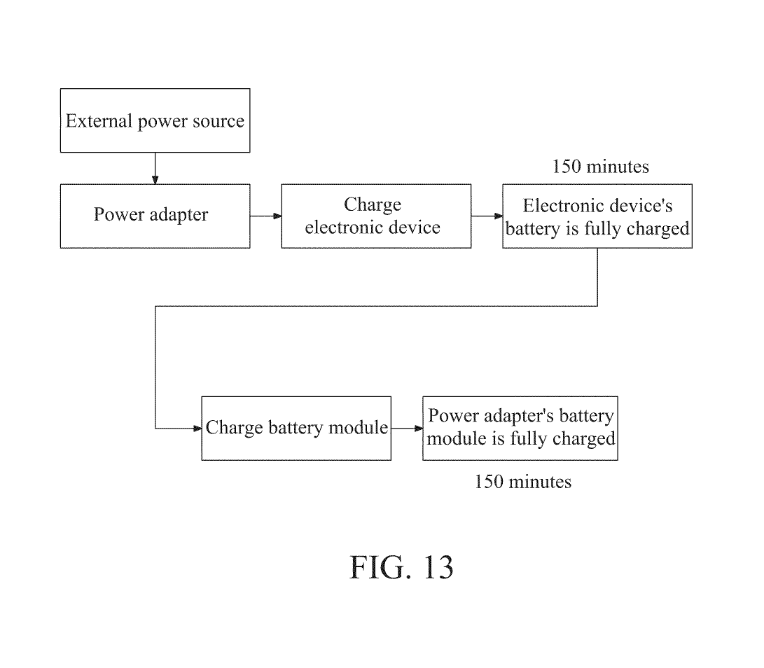

Please refer to FIG. 13, which shows the charging sequence according to a conventional power adapter 11 with built-in battery 14. As shown, the conventional power adapter 11 with built-in battery 14 is connected to an external power source 13, and an electronic device 10 connected to the conventional power adapter 11 is charged via the external power source 13 at a first priority. The charging of the built-in battery 14 of the conventional power adapter 11 will start only when the battery of the electronic device 10 is fully charged. And, the charging procedure stops when the built-in battery 14 is fully charged. Supposing it takes 150 minutes for the conventional power adapter 11 to fully charge the electronic device 10 and another 150 minutes to fully charge the built-in battery 14, total 300 minutes are needed by the conventional power adapter 11 with built-in battery 14 to complete the charging.

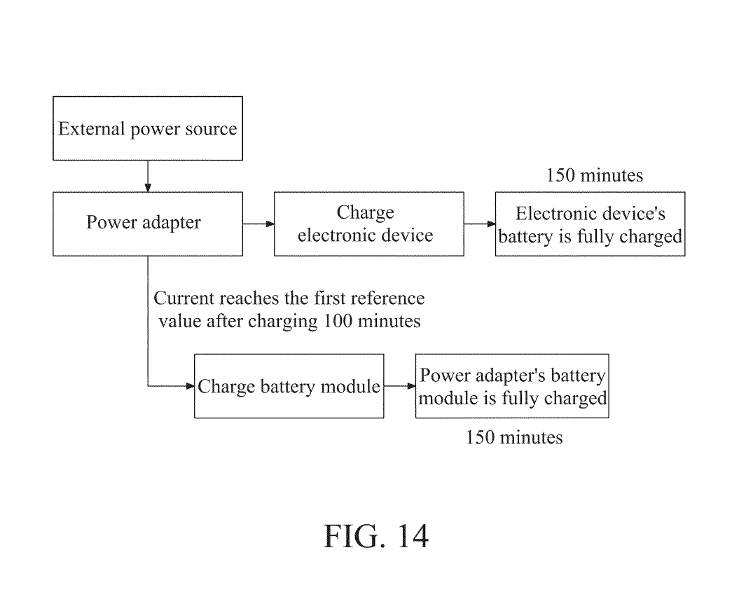

On the other hand, FIG. 14 shows a first charging sequence according to the power adapter 20 of the present invention. As shown, when the power adapter 20 is connected to an external power source 26 and an electronic device 27, the power adapter 20 obtains electric current from the external power source 26 to charge the electronic device 27 at a first priority. When the battery capacity of the electronic device 27 reaches a first reference value, the charging current is divided to also charge the battery module 23 of the power adapter 20. Then, the battery module 23 and the electronic device 27 are charged at the same time until both of them are fully charged.

Supposing it takes 150 minutes for the power adapter 20 to fully charge the electronic device 27, and another 150 minutes to fully charge the battery module 23. However, since the charging current is divided to also charge the battery module 23 when the electronic device 27 has been charged for 100 minutes, total 50 minutes of charging time can be saved. That is, the total time needed to fully charge the battery module 23 and the electronic device 27 is shortened to 250 minutes, which is about 16.7% shorter than the total charging time needed by the conventional power adapter with built-in battery. Of course, the power adapter 20 can also be set, for example, to divide the charging current for charging the battery module 23 when the electronic device 27 has been charged for 50 minutes, so as to save more charging time.

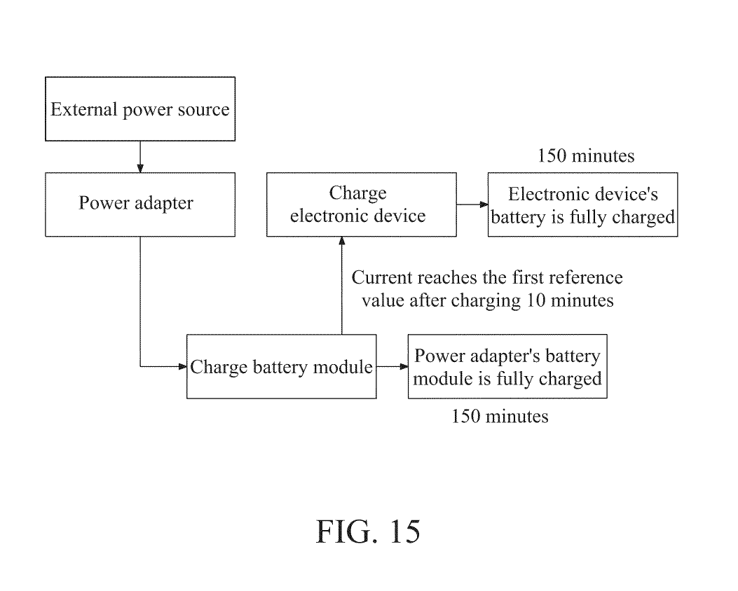

Please refer to FIG. 15 that shows a second charging sequence according to the power adapter 20 of the present invention. When the power adapter 20 with built-in battery according to the present invention is connected to an external power source 26 and an electronic device 27, the internal battery module 23 of the power adapter 20 is charged via the external power source 26 at a first priority. When the current of the battery module 23 reaches a first reference value, the charging current is divided to also charge the battery of the electronic device 27. At this point, the charging current is supplied from the power system 22 or the battery module 23, and the battery module 23 and the electronic device 27 are charged at the same time until both of them are fully charged.

Supposing it takes 150 minutes for the power adapter 20 to fully charge the electronic device 27 and another 150 minutes to fully charge the battery module 23.

However, since the charging current is divided to also charge the electronic device 27 when the battery module 23 has been charged for 10 minutes, total 140 minutes of charging time can be saved. That is, the total time needed to fully charge the battery module 23 and the electronic device 27 is shortened to 160 minutes, which is about 46.7% shorter than the total charging time needed by the conventional power adapter with built-in battery.

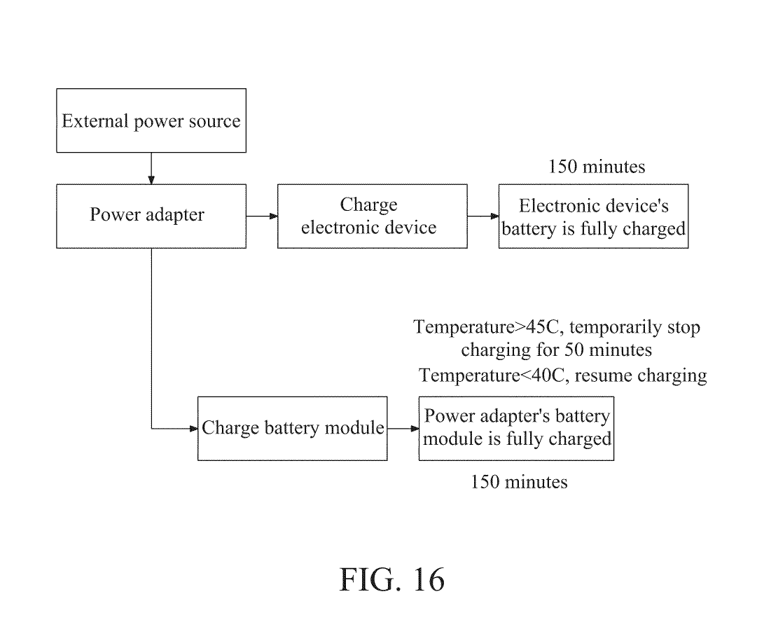

Please refer to FIG. 16 that is a block diagram showing a third charging sequence according to the power adapter 20 of the present invention. As shown, the power adapter 20 with built-in battery according to the present invention is powered via the external power source 26, and the power adapter 20 charges the battery module 23 and the electronic device 27 at the same time until both of the battery module 23 and the electronic device 27 are fully charged. During charging, when the temperature of the battery module 23 rises above a preset value, the charging to the battery module 23 is temporarily stopped until the temperature of the battery module 23 drops below another preset value. Then, the charging to the battery module 23 is resumed.

Supposing that it takes 150 minutes for the power adapter 20 to fully charge the electronic device 27, and it also takes 150 minutes for the power adapter 20 to fully charge the battery module 23. When the charging starts, the electronic device 27 and the battery module 23 are charged at the same time. The charging to the battery module 23 is temporarily stopped when the battery module 23 has a temperature higher than 45° C.; and the charging to the battery module 23 resumes when the battery module's temperature drops below 40° C. Wherein, the charging to the battery module is temporarily stopped for about 50 minutes, so that the total time to fully charge the battery module 23 is 200 minutes, which is about 33.3% shorter than the time needed by the conventional power adapter with built-in battery to complete the charging.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A power storage and supply method for a power adapter with built-in battery, comprising the following steps:
(A) determining whether or not the power adapter is connected to an external power source; wherein the power adapter includes at least one microcontroller, a power system, and at least one battery module built in the power adapter;
(B) if yes, further determining whether or not the power adapter is connected to at least one electronic device;
(C) if yes, selecting to charge the electronic device or the battery module as a first charging mode;
(D) determining whether or not a physical quantity of the power adapter reaches a first reference value; and
(E) if yes, selecting to charge the electronic device and/or the battery module as a second charging mode.

2. The power storage and supply method as claimed in claim 1, wherein the step (E) further includes the following steps:
determining whether or not the physical quantity of the power adapter reaches a second reference value; and
if yes, stopping charging the battery module or stopping charging the battery module and the electronic device.

3. The power storage and supply method as claimed in claim 1, further comprising a step (F) to charge the battery module of the power adapter via the external power source when the power adapter is not connected to the electronic device.

4. The power storage and supply method as claimed in claim 3, wherein the step (F) further includes the following steps:
determining whether or not the physical quantity of the power adapter reaches a third reference value; and
if yes, stopping charging the battery module via the external power source.

5. The power storage and supply method as claimed in claim 3, further comprising a step (G) to charge the electronic device via the battery module of the power adapter when the power adapter is not connected to the external power source.

6. The power storage and supply method as claimed in claim 5, wherein the step (G) further includes the following steps:
determining whether or not the physical quantity of the power adapter reaches a fourth reference value; and
if yes, stopping charging the electronic device via the battery module.

7. The power storage and supply method as claimed in claim 1, wherein, in the first charging mode, the electronic device is charged at a first priority; and in the second charging mode, the electronic device and the battery module are charged at the same time.

8. The power storage and supply method as claimed in claim 1, wherein, in the first charging mode, the electronic device is charged at a first priority; and in the second charging mode, the battery module is charged.

9. The power storage and supply method as claimed in claim 1, wherein, in the first charging mode, the battery module is charged at a first priority; and in the second charging mode, the electronic device and the battery module are charged at the same time.

10. The power storage and supply method as claimed in claim 1, wherein, in the first charging mode, the battery module is charged at a first priority; and in the second charging mode, the electronic device is charged.

11. The power storage and supply method as claimed in claim 10, wherein, in the second charging mode, the external power source is used to supply current for charging.

12. The power storage and supply method as claimed in claim 10, wherein, in the second charging mode, the battery module is used to supply current for charging.

13. The power storage and supply method as claimed in claim 1, wherein the physical quantity is selected from the group consisting of electric current, voltage, temperature and magnetic field.

14. A power storage and supply method for a power adapter with built-in battery, comprising the following steps:
(A) determining whether or not the power adapter is connected to an external power source; wherein the power adapter includes at least one microcontroller, a power system and at least one battery module built in the power adapter;
(B) if yes, further determining whether or not the power adapter is connected to at least one electronic device; and
(C) if yes, charging the electronic device and the battery module at the same time as a first charging mode.

15. The power storage and supply method as claimed in claim 14, further comprising the following steps:
(D) determining whether or not a first physical quantity of the power adapter reaches a first reference value; and
(E) if yes, stopping charging the electronic device as a second charging mode.

16. The power storage and supply method as claimed in claim 15, wherein the step (E) further includes the following steps:
determining whether or not the first physical quantity of the power adapter reaches a second reference value; and
if yes, stopping charging the battery module.

17. The power storage and supply method as claimed in claim 15, wherein the step (E) further includes the following steps:
determining whether or not the first physical quantity of the power adapter reaches a second reference value;
if not, further determining whether or not a second physical quantity of the power adapter reaches a fifth reference value;
if yes, temporarily stopping charging the battery module;
determining whether or not the second physical quantity of the power adapter reaches a sixth reference value; and
if yes, resuming charging the battery module.

18. The power storage and supply method as claimed in claim 17, wherein the first physical quantity is electric current and the second physical quantity is temperature.

19. The power storage and supply method as claimed in claim 15, further comprising the following step:
(F) charging the battery module of the power adapter via the external power source when the power adapter is not connected to the electronic device.

20. The power storage and supply method as claimed in claim 19, wherein the step (F) further includes the following steps:
determining whether or not the first physical quantity of the power adapter reaches a third reference value; and
if yes, stopping charging the battery module via the external power source.

21. The power storage and supply method as claimed in claim 19, further comprising the following step:
(G) charging the electronic device via the battery module of the power adapter when the power adapter is not connected to the external power source.

22. The power storage and supply method as claimed in claim 21, wherein the step (G) further includes the following steps:
determining whether or not the first physical quantity of the power adapter reaches a fourth reference value; and
if yes, stopping charging the electronic device via the battery module.

23. A power adapter with built-in battery being selectively connected to an external power source and/or at least one electronic device, comprising:
an input connector for electrically connecting to the external power source;
at least one output connector for electrically connecting to the at least one electronic device;
a power system being electrically connected to between the input connector and the output connector for converting current and voltage received from the external power source;
at least one built-in battery module being electrically connected to the power system and the output connector for storing power supplied thereto by the power system; and
at least one microcontroller being electrically connected to the input connector, the output connector, the power system and the battery module for determining states of connection of the input connector and the output connector to the external power source and the electronic device, respectively, and, based on the determined connection states, selectively instructing the power system to supply power to the battery module and/or the output connector or instructing the battery module to supply power to the output connector;
wherein when the input connector and the output connector are simultaneously connected to the external power source and the electronic device, respectively, the power system charges the electronic device or the battery module as a first charging mode; and when the microcontroller detects a physical quantity of the power adapter reaches a first reference value, the power system charges the battery module and/or the electronic device as a second charging mode.

24. The power adapter with built-in battery as claimed in claim 23, wherein, in the first charging mode, the electronic device is charged at a first priority; and in the second charging mode, the electronic device and the battery module are charged at the same time.

25. The power adapter with built-in battery as claimed in claim 23, wherein, in the first charging mode, the electronic device is charged at a first priority; and in the second charging mode, the battery module is charged.

26. The power adapter with built-in battery as claimed in claim 23, wherein, in the first charging mode, the battery module is charged at a first priority; and in the second charging mode, the electronic device and the battery module are charged at the same time.

27. The power adapter with built-in battery as claimed in claim 23, wherein, in the first charging mode, the battery module is charged at a first priority; and in the second charging mode, the electronic device is charged.

28. The power adapter with built-in battery as claimed in claim 23, wherein the physical quantity is selected from the group consisting of current, voltage, temperature and magnetic field.
